(19) United States
(12) Patent Application Publication
(10) Pub. No.: US 2016/0222288 A1
(43) Pub. Date: Aug. 4, 2016

(54) METHOD FOR PRODUCING SILICATE PHOSPHOR

(71) Applicant: UBE MATERIAL INDUSTRIES, LTD., Ube-shi, Yamaguchi (JP)

(72) Inventors: Koichi FUKUDA, Ube-shi, Yamaguchi (JP); Kenji ARIMA, Ube-shi, Yamaguchi (JP); Jin AMAGAI, Ube-shi, Yamaguchi (JP)

(21) Appl. No.: 15/021,329

(22) PCT Filed: Sep. 12, 2014
(86) PCT No.: PCT/JP2014/074274

§ 371 Date: Mar. 11, 2016

(30) Foreign Application Priority Data
Sep. 13, 2013 (JP) 2013-190666

(51) Int. Cl. C09K 11/77

(52) U.S. Cl. CPC C09K 11/7734

(57) ABSTRACT

A silicate phosphor produced by a method of firing in a reducing atmosphere a mixture comprising a silicon compound, a strontium compound and a barium compound in a ratio providing strontium barium silicate and a europium compound in the presence of two or more halide compounds selected from a group consisting of fluoride, chloride and bromide exhibits higher external quantum efficiency to a light in the wavelength region of ultraviolet light to blue light, as compared with a silicate phosphor produced by a method of firing in a reducing atmosphere the mixture in the presence of a single halide.

### FIELD OF THE INVENTION

The present invention relates to a method for producing a silicate phosphor. In particular, the invention relates to a method for producing a silicate phosphor which comprises strontium barium silicate activated with europium.

### BACKGROUND OF THE INVENTION

Strontium barium silicate (elementary constitutional formula: SrOBaOSiO₂) activated with europium is known as a green light-emitting silicate phosphor. This silicate phosphor is generally produced by firing a mixture comprising a silicon compound, a strontium compound, a barium compound and a europium compound. For the production of the silicate phosphor, it has been studied to add a flux (i.e., firing auxiliaries) to the mixture so as to enhance the light-emitting property and productivity.

Patent Document 1 (JP 2009-108327 A) describes a silicate phosphor having the following formula:

(M^{I}₍₁₋ₓ₎M^{II}ₓ)_{α}SiO_{β}

in which M^{I} represents at least one atom selected from the group consisting of Ba, Ca, Sr, Zn and Mg; M^{II} represents at least one divalent or trivalent metal atom; x, α and β are numbers satisfying the conditions of 0.01<x<0.3, 1.5≦α≦2.5 and 3.5≦β≦4.5.

Patent Document 1 further has a description to use a combination of a crystal growth-enhancing flux and a crystal growth-restraining flux in the production of the above-mentioned silicate phosphor. Patent Document 1 indicates that the use of the combination of the above-mentioned two fluxes is effective to produce a phosphor showing a high luminance and having a size of well restrained crystal growth and an easily handled weight median diameter. There are furthermore described divalent atom-containing compounds such as SrCl₂ and BaCl₂ as the crystal growth-enhancing flux and monovalent or trivalent atom-containing compounds such as CsCl, LiCl and YCl₃.6H₂O as the crystal growth-restraining flux.

Patent Document 2 (JP 2007-23129 A) describes a silicate phosphor having the following formula:

(BaₐCa_{b}Sr_{c}Mg_{d}Euₓ)SiO₄

in which a, b, c, d and x are numbers satisfying the conditions of a+b+c+d+x=2, 0<a<2, 0<b<2, 0≦c<1.0, 0≦d<0.9 and 0<x≦0.5, and 50% or more of Eu ions are Eu²⁺ ions.

Patent Document 2 further has a description to indicate that the starting mixture can be admixed with flux, if desired, and the admixture of flux is expected to enhance grain growth and lowering the reaction temperature, and therefore the use of flux is effective to produce preferred phosphors. Examples of the flux described in Patent Document 2 are ammonium halides such as NH₄Cl and NH₄F.HF, alkali metal carbonates such as NaCO₃ and LiCO₃, alkali metal halides such as LiCl, NaCl and KCl, alkaline earth metal halides such as CaCl₂, CaF₂ and BaF₂, borate compounds such as B₂O₃, H₃BO₃ and NaB₄O₇, and phosphate compounds such as Li₃PO₄ and NH₄H₂PO₄. These fluxes can be used singly or in combination.

Patent Document 3 (JP 2013-136697 A) describes a green light-emitting silicate phosphor which is strontium barium silicate activated with europium. This silicate phosphor has at least one crystal phase such as magnesium oxide phase and Merwinite phase and contains magnesium in an amount of 0.15 to 0.90 mole per one mole of silicon. The document refers to flux and describes that the flux preferably is a halide, most preferably chloride.

It has been studied to utilize a silicate phosphor such as strontium barium silicate activated with europium as a green light-emitting source in a white light LED. The green light-emitting phosphor used in the white light LED is required to emit a green light efficiently upon irradiation with a light in the wavelength region of ultraviolet light to blue light. In other words, the green light-emitting phosphor is required to show high external quantum efficiency to a light in the wavelength region of ultraviolet light to blue light.

### SUMMARY OF THE INVENTION

Accordingly, it is an object of the invention to provide a method for producing advantageously in industry a silicate phosphor which shows high external quantum efficiency to a light in the wavelength region of ultraviolet light to blue light.

The present inventors have found that a silicate phosphor produced by a method of firing in a reducing atmosphere a mixture comprising a silicon compound, a strontium compound and a barium compound in a ratio providing strontium barium silicate and an europium compound in the presence of two or more halide compounds selected from a group consisting of fluoride, chloride and bromide exhibits higher external quantum efficiency to a light in the wavelength region of ultraviolet light to blue light, as compared with a silicate phosphor produced by a method of firing in a reducing atmosphere the mixture in the presence of a single halide.

The present invention has been made based on the above-mentioned finding.

Accordingly, the present invention resides in a method for producing a silicate phosphor which comprises firing in a reducing atmosphere a mixture comprising a silicon compound, a strontium compound and a barium compound in a ratio providing strontium barium silicate and an europium compound in the presence of two or more halide compounds selected from a group consisting of fluoride, chloride and bromide, said halide compounds being contained in the mixture.

Preferred embodiments of the present invention are described below.

(1) The mixture contains the europium compound in an amount in the range of 0.005 to 0.2 mole in terms of an amount of a europium atom, per one mole of a silicon atom contained in the silicon compound.

(2) The mixture contains two or more halide compounds in an amount in the range of 0.01 to 0.5 mole in terms of a total amount of halogen atoms contained in the whole halide compounds, per one mole of a silicon atom contained in the silicon compound.

(3) The mixture contains a magnesium compound in an amount in the range of 0.15 to 0.90 mole in terms of an amount of a magnesium atom, per one mole of a silicon atom contained in the silicon compound.

(4) Each of the two or more halogen compounds is a halide of an atom selected from the group consisting of silicon, strontium, barium, europium and magnesium.

(5) The two or more halide compounds comprise a fluoride and a bromide in a molar ratio in the range of 1:9 to 9:1.

(6) The two or more halide compounds comprise a chloride and a bromide in a molar ratio in the range of 1:9 to 9:1.

(7) The method comprises a step of calcining the mixture in an oxygen-containing atmosphere in advance of firing the mixture in a reducing atmosphere.

### EFFECTS OF THE INVENTION

The method of the invention can be advantageously utilized to produce advantageously in industry a silicate phosphor showing high external quantum efficiency when it is irradiated with a light in the wavelength region of ultraviolet light to blue light.

### EMBODIMENTS FOR PERFORMING THE INVENTION

In the method of the invention for producing a silicate phosphor, the silicate phosphor is a strontium barium silicate activated with europium. This silicate phosphor preferably is a green light-emitting phosphor which emits a green light with a peak wavelength in the range of 510 to 530 nm when irradiated with a light having a wavelength of 400 nm.

In the method of the invention, the strontium barium silicate preferably is a silicate phosphor having the following formula (I):

wBaO.xSrO.SiO₂ (I)

in which w and x independently represents a number in the range of 0.10 to 2.00 and total of w and x is in the range of 1.50 to 2.50.

In the method of the invention, the silicate phosphor produced by the method is a silicate phosphor having one of the following formulas (II) and (III):

wBaO.xSrO.yEuO.SiO₂ (II)

in which each of w and x is the same as that in the formula (I), and y is a number in the range of 0.005 to 0.20,

wBaO.xSrO.yEuO.SiO₂.zMgO (III)

in which each of w and x is the same as that in the formula (I), y is the same as that in the formula (II), and z is a number in the range of 0.15 to 0.90.

In the formulas (I) to (III), each of w and x is preferred independently to be a number in the range of 0.50 to 1.50, more preferably in the range of 0.90 to 1.10. y preferably is a number in the range of 0.01 to 0.10, more preferably in the range of 0.02 to 0.07. The total of w, x and y preferably is in the range of 1.70 to 2.10, more preferably in the range of 1.80 to 1.98. It is preferred that z is in the range of 0.20 to 0.80.

In the silicate phosphor of the formula (III), magnesium oxide (MgO) may form a crystal phase of magnesium oxide or a crystal phase of Merwinite. In the invention, the crystal phase of Merwinite means a crystal phase corresponding to the crystal phase of Merwinite (3CaO.MgO.2SiO₂). It is considered that the phosphor of the invention has a crystal of 3(BaO,SrO)₃.MgO.2SiO₂ which is in the crystal phase of Merwinite.

The method of the invention for producing a silicate phosphor comprises a step of firing a mixture of the starting compounds for the phosphor production in the presence of two or more halide compounds selected from fluoride, chloride and bromide in a reducing atmosphere. The starting compounds comprise a silicon compound, a strontium compound, a barium compound, and a europium compound. The starting compound may comprise a magnesium compound. In the starting mixture, the silicon compound, strontium compound and barium compound are present in the ratio to produce a strontium barium silicate of the afore-mentioned formula (I). The europium compound is generally contained in an amount of 0.005 to 0.2 mole in terms of the amount of europium atom, per one mole of the amount of silicon atom in silicon compound. The magnesium compound is generally contained in an amount of 0.15 to 0.90 mole in terms of the amount of magnesium atom, per one mole of the amount of silicon atom in the silicon compound.

Each of the starting compounds, namely, the strontium compound, barium compound, silicon compound and europium compound, can be an oxide or a compound capable of producing an oxide by heating, such as a hydroxide, a halide, a carbonate (including a basic carbonate), a nitrate, or an oxalate. Each compound can be employed singly or in combination. The compound preferably has a purity of 99 wt. % or higher.

The two or more halides preferably are present in solid forms in the starting mixture before subjecting to firing. In other words, the halides preferably are solid at room temperature. The cation atoms of the two or more halides can be the same or different from each other. Each of the two or more halides preferably is a halide of a cation atom contained in the silicate phosphor, for example, a halide of silicon, strontium, barium, europium or magnesium. Preferred is a halide of an alkaline earth atom such as strontium, barium or magnesium, and the most preferred is strontium halide.

The two or more halides are used generally in an amount of 0.01 to 0.5 mole, preferably 0.02 to 0.5 mole, in terms of the total amount of halogen atoms contained in the two or more halides, per one mole of the amount of silicon atom in the silicon compound.

The two or more halides can be a combination of a fluoride, a chloride and a bromide, a combination of a fluoride and a bromide, a combination of a chloride and a bromide, or a combination of a fluoride and a chloride. Preferred are the combination of a fluoride and a bromide and the combination of a chloride and a bromide. In the former combination, the fluoride and bromide are generally used in a molar ratio of 1:9 to 9:1, preferably 2:8 to 8:2, more preferably 3:7 to 7:3 in terms of the halogen amount. In the latter combination, the chloride and bromide are generally used in a molar ratio of 1:9 to 9:1, preferably 2:8 to 8:2, more preferably 3:7 to 7:3 in terms of the halogen amount.

The starting mixture for the production of the silicate phosphor can be prepared by mixing the starting compounds under dry conditions (i.e., dry mixing) or wet conditions (i.e., wet mixing). The wet mixing can be carried out by means of a rotary ball mill, a vibration ball mill, an epicyclic mill, a paint shaker, a rocking mill, a rocking mixer, a bead mill or a stirrer. In the wet mixing, a solvent such as water or a lower alcohol (e.g., ethanol or isopropyl alcohol) can be employed.

The firing of the starting mixture is performed in a reducing atmosphere. The reducing atmosphere preferably is a gaseous atmosphere comprising 0.5 to 5.0 vol. % of hydrogen and 99.5 to 95.0 vol. % of an inert gas. The inert gas may be argon or nitrogen. The firing is generally carried out at a temperature in the range of 900 to 1,300° C., for a period of 0.5 to 100 hours, preferably 0.5 to 10 hours.

The starting mixture can be calcined in an oxygen-containing atmosphere in advance of performing the firing of the starting compound in a reducing atmosphere. In particular, if the starting mixture contains starting compounds turning to oxides by heating, the calcination in an oxygen-containing atmosphere is preferably adopted.

The oxygen-containing atmosphere is preferably formed of air. The calcination is preferably carried out at a temperature in the range of 600 to 1,000° C., for 0.5 to 100 hours, preferably 0.5 to 10 hours. The silicate phosphor produced by the firing can be subjected to classification, acid-washing using a mineral acid such as hydrochloric acid or nitric acid, and baking treatment.

The silicate phosphor produced by the method of the invention exhibits higher external quantum efficiency to a light in the wavelength region of ultraviolet light to blue light (i.e., 200 to 450 nm), as compared with a silicate phosphor produced by a method using one halide. Accordingly, the silicate phosphor produced by the method of the invention can be advantageously employed as a green light-emitting phosphor to be placed in a white light LED using an irradiating light in the wavelength of ultraviolet light to blue light.

### EXAMPLES

In the below-described examples, the following powdery starting compounds were employed.

(1) powdery strontium carbonate (SrCO₃)
purity: 99.99 wt. %, mean particle diameter: 2.73 μm
   (2) powdery barium carbonate (BaCO₃)
purity: 99.8 wt. %, mean particle diameter: 1.26 μm
   (3) powdery europium oxide (Eu₂O₃)
purity: 99.9 wt. %, mean particle diameter: 2.71 μm
   (4) powdery silicon oxide (SiO₂)
purity: 99.9 wt. %, mean particle diameter: 3.87 μm
   (5) powdery magnesium oxide (MgO)
purity: 99.98 wt. %, BET specific surface area: 8 m²/g, prepared by a gaseous phase process
   (6) powdery strontium fluoride (SrF₂)
purity: 99 wt. %
   (7) powdery strontium chloride hexahydrates (SrCl₂)
purity: 99 wt. %
   (8) powdery strontium bromide (SrBr₂)
purity: 99 wt. %
   (9) magnesium fluoride powder (MgF₂)
purity: 98 wt. %
   (10) powdery magnesium bromide (MgBr₂)
purity: 99.9 wt. %

### Example 1

The powders of SrCO₃, BaCO₃, Eu₂O₃, SiO₂, MgO, SrF₂ and SrBr₂ were weighed to give a composition in the molar ratio of 0.985:0.850:0.020:1:0.300:0.010:0.015. These powders were placed in a ball mill together with isopropyl alcohol, and mixed for 24 hours, to give a slurry of the powdery mixture. The slurry of the powdery mixture was then dried in a rotary evaporator. The resulting dry powdery mixture was placed in an alumina crucible and calcined in the airy atmosphere at 900° C. for 3 hours. The calcined product was cooled to room temperature and fired at 1,200° C., for 6 hours in a reducing atmosphere comprising 3 vol. % hydrogen and 97 vol. % argon. There was produced a silicate phosphor having a constitutional formula of:

1.010SrO.0.850BaO.0.040EuO.SiO₂.0.300MgO

### Example 2 and Comparison Examples 1 to 3

The procedures of Example 1 were repeated except that a starting mixture was prepared from the powders of SrCO₃, BaCO₃, Eu₂O₃, SiO₂, MgO, SrF₂, SrCl₂ and SrBr₂ in a molar ratio described in Table 1, to produce a silicate phosphor.

TABLE 1

| | SrCO₃ | BaCO₃ | Eu₂O₃ | SiO₂ | MgO | SrF₂ | SrCl₂ | SrBr₂ |
|---|---|---|---|---|---|---|---|---|
| Example 1 | 0.985 | 0.850 | 0.020 | 1 | 0.300 | 0.010 | 0 | 0.015 |
| Example 2 | 0.985 | 0.850 | 0.020 | 1 | 0.300 | 0 | 0.010 | 0.015 |
| Com. Ex. 1 | 0.985 | 0.850 | 0.020 | 1 | 0.300 | 0.025 | 0 | 0 |
| Com. Ex. 2 | 0.985 | 0.850 | 0.020 | 1 | 0.300 | 0 | 0.025 | 0 |
| Com. Ex. 3 | 0.985 | 0.850 | 0.020 | 1 | 0.300 | 0 | 0 | 0.025 |

### [Evaluation]

Each of the silicate phosphor produced in Examples 1 & 2 and Comparison Examples 1 to 3 was subjected to measurement of external quantum efficiency in the below-described manner. The results of the measurements are set forth in Table 2 together with the amount (in terms of the molar ratio) of halides (SrF₂, SrCl₂, SrBr₂).

### [Measurement of External Quantum Efficiency]

1) A standard white surface plate is fixed to an inner bottom of an integrating sphere. The standard white surface plate is irradiated perpendicularly with a ultraviolet light having a peak wavelength of 400 nm. The spectrum of light scattered on the wall of the integrating sphere is detected, and a peak area (L₁ of the light in the wavelength region of 380 to 410 nm is measured.

2) The powdery silicate phosphor (specimen) is placed in a specimen holder, and the holder is fixed to the inner bottom of the integrating sphere. The powdery silicate phosphor specimen in the holder plate is irradiated perpendicularly with a ultraviolet light having a peak wavelength of 400 nm. The spectrum of light scattered on the wall of the integrating sphere is detected, and a peak area (E) of the light in the wavelength region of 410 to 700 nm is measured.

The external quantum efficiency of the silicate phosphor specimen is calculated using the following equation:

External quantum efficiency (%)=100×E/L₁

TABLE 2

| | | | | External quantum |
|---|---|---|---|---|
| | | | | efficiency |
| | SrF₂ | SrCl₂ | SrBr₂ | (%) |
| Example 1 | 0.010 | 0 | 0.015 | 68.2 |
| Example 2 | 0 | 0.010 | 0.015 | 67.4 |
| Com. Ex. 1 | 0.025 | 0 | 0 | 64.4 |
| Com. Ex. 2 | 0 | 0.025 | 0 | 65.0 |
| Com. Ex. 3 | 0 | 0 | 0.025 | 64.7 |

### Constitutional Formula of Silicate Phosphor:

1.010SrO.0.850BaO.0.040EuO.SiO₂.0.300MgO

From the results set forth in Table 2, it is understood that the silicate phosphor (Example 1) prepared from the powdery mixture containing a combination of two halides, namely, strontium fluoride and strontium bromide and the silicate phosphor (Example 2) prepared from the powdery mixture containing two halides, namely, strontium chloride and strontium bromide both exhibit higher external quantum efficiency than the silicate phosphors (Comparison Examples 1 to 3) prepared from the powdery mixture containing a single strontium halide.

### Examples 3 & 4 and Comparison Examples 4 to 6

The procedures of Example 1 were repeated except that a starting mixture was prepared from the powders of SrCO₃, BaCO₃, Eu₂O₃, SiO₂, MgO, SrF₂, SrCl₂ and SrBr₂ in a molar ratio described in Table 3.

The produced silicate phosphors were subjected to the measurement of external quantum efficiency in the above-mentioned manner. The results of measurements are set forth in Table 4 together with the amount (in terms of the molar ratio) of halides (SrF₂, SrCl₂, SrBr₂).

TABLE 3

| | SrCO₃ | BaCO₃ | Eu₂O₃ | SiO₂ | MgO | SrF₂ | SrCl₂ | SrBr₂ |
|---|---|---|---|---|---|---|---|---|
| Example 3 | 0.980 | 0.850 | 0.020 | 1 | 0.300 | 0.010 | 0 | 0.020 |
| Example 4 | 0.980 | 0.850 | 0.020 | 1 | 0.300 | 0 | 0.010 | 0.020 |
| Com. Ex. 4 | 0.980 | 0.850 | 0.020 | 1 | 0.300 | 0.030 | 0 | 0 |
| Com. Ex. 5 | 0.980 | 0.850 | 0.020 | 1 | 0.300 | 0 | 0.030 | 0 |
| Com. Ex. 6 | 0.980 | 0.850 | 0.020 | 1 | 0.300 | 0 | 0 | 0.030 |

TABLE 4

| | | | | External quantum |
|---|---|---|---|---|
| | | | | efficiency |
| | SrF₂ | SrCl₂ | SrBr₂ | (%) |
| Example 3 | 0.010 | 0 | 0.020 | 67.9 |
| Example 4 | 0 | 0.010 | 0.020 | 67.1 |
| Com. Ex. 4 | 0.030 | 0 | 0 | 65.1 |
| Com. Ex. 5 | 0 | 0.030 | 0 | 66.3 |
| Com. Ex. 6 | 0 | 0 | 0.030 | 64.7 |

### Constitutional Formula of Silicate Phosphor:

1.010SrO.0.850BaO.0.040EuO.SiO₂.0.300MgO

From the results set forth in Table 4, it is understood that the silicate phosphors prepared from the powdery mixture containing a combination of two halides both exhibit higher external quantum efficiency than the silicate phosphors prepared from the powdery mixture containing a single strontium halide, even in the case that the halide was used in an amount of 0.030 mole in the starting powdery mixture.

### Example 5 and Comparison Examples 7 & 8

The procedures of Example 1 were repeated except that a starting mixture was prepared from the powders of SrCO₃, BaCO₃, Eu₂O₃, SiO₂, MgO, MgF₂ and MgBr₂ in a molar ratio described in Table 5.

The produced silicate phosphors were subjected to the measurement of external quantum efficiency in the aforementioned manner. The results of the measurements are set forth in Table 6 together with the amount (in terms of the molar ratio) of halides (MgF₂, MgBr₂).

TABLE 5

| | SrCO₃ | BaCO₃ | Eu₂O₃ | SiO₂ | MgO | MgF₂ | MgBr₂ |
|---|---|---|---|---|---|---|---|
| Example 5 | 1.015 | 0.850 | 0.0175 | 1 | 0.275 | 0.010 | 0.015 |
| Com. Ex. 7 | 1.015 | 0.850 | 0.0175 | 1 | 0.275 | 0.025 | 0 |
| Com. Ex. 8 | 1.015 | 0.850 | 0.0175 | 1 | 0.275 | 0 | 0.025 |

TABLE 6

| | | | External quantum |
|---|---|---|---|
| | | | efficiency |
| | MgF₂ | MgBr₂ | (%) |
| Example 5 | 0.010 | 0.015 | 69.1 |
| Com. Ex. 4 | 0.025 | 0 | 65.1 |
| Com. Ex. 6 | 0 | 0.025 | 64.1 |

### Constitutional Formula of Silicate Phosphor:

1.015SrO.0.850BaO.0.035EuO.SiO₂.0.300MgO

From the results stated in Table 6, it is understood that the silicate phosphor prepared from the powdery mixture containing a combination of two halides exhibits higher external quantum efficiency than the silicate phosphors prepared from the powdery mixture containing a single halide, even in the case that the halide was magnesium halide.

### Example 6 and Comparison Examples 9 & 10

The procedures of Example 1 were repeated except that a starting mixture was prepared from the powders of SrCO₃, BaCO₃, Eu₂O₃, SiO₂, SrF₂ and SrBr₂ in a molar ratio described in Table 7.

The produced silicate phosphors were subjected to the measurement of external quantum efficiency in the aforementioned manner. The results of the measurements are set forth in Table 8 together with the amount (in terms of the molar ratio) of halides (SrF₂, SrBr₂).

TABLE 7

| | SrCO₃ | BaCO₃ | Eu₂O₃ | SiO₂ | SrF₂ | SrBr₂ |
|---|---|---|---|---|---|---|
| Example 6 | 1.100 | 0.850 | 0.0175 | 1 | 0.005 | 0.010 |
| Com. Ex. 9 | 1.100 | 0.850 | 0.0175 | 1 | 0.015 | 0 |
| Com. Ex. 10 | 1.100 | 0.850 | 0.0175 | 1 | 0 | 0.015 |

TABLE 8

| | | | External quantum |
|---|---|---|---|
| | | | efficiency |
| | SrF₂ | SrBr₂ | (%) |
| Example 6 | 0.005 | 0.010 | 64.1 |
| Com. Ex. 9 | 0.015 | 0 | 62.0 |
| Com. Ex. 10 | 0 | 0.015 | 59.5 |

### Constitutional Formula of Silicate Phosphor:

1.115SrO.0.850BaO.0.035EuO.SiO₂

From the results set forth in Table 8, it is understood that the silicate phosphor prepared from the powdery mixture containing a combination of two halides exhibits higher external quantum efficiency than the silicate phosphors prepared from the powdery mixture containing a single halide, even in the case that no MgO is contained.

What is claimed is:

1. A method for producing a silicate phosphor which comprises firing in a reducing atmosphere a mixture comprising a silicon compound, a strontium compound and a barium compound in a ratio providing strontium barium silicate and a europium compound in the presence of two or more halide compounds selected from a group consisting of a fluoride, a chloride and a bromide, said halide compounds being contained in the mixture.

2. The method of claim 1, wherein the mixture contains the europium compound in an amount in the range of 0.005 mole to 0.2 mole in terms of an amount of a europium atom, per one mole of a silicon atom contained in the silicon compound.

3. The method of claim 1, wherein the mixture contains two or more halide compounds in an amount in the range of 0.01 mole to 0.5 mole in terms of a total amount of halogen atoms contained in the whole halide compounds, per one mole of a silicon atom contained in the silicon compound.

4. The method of claim 1, wherein the mixture contains a magnesium compound in an amount in the range of 0.15 to 0.90 mole in terms of an amount of a magnesium atom, per one mole of a silicon atom contained in the silicon compound.

5. The method of claim 1, wherein each of the two or more halide compounds is a halide of an atom selected from the group consisting of silicon, strontium, barium, europium and magnesium.

6. The method of claim 1, wherein the two or more halide compounds comprise a fluoride and a bromide in a molar ratio in the range of 1:9 to 9:1.

7. The method of claim 1, wherein the two or more halogen compounds comprise a chloride and a bromide in a molar ratio in the range of 1:9 to 9:1.

8. The method of claim 1, which comprises a step of calcining the mixture in an oxygen-containing atmosphere in advance of firing the mixture in a reducing atmosphere.
